(19) United States
(12) Patent Application Publication
(10) Pub. No.: US 2004/0126631 A1
(43) Pub. Date: Jul. 1, 2004

(54) Fuel-regenerable fuel cell, system and process for generating power and process for regenerating fuel

(76) Inventors: Isamu Uchida, Miyagi (JP); Minoru Umeda, Niigata (JP); Hiroyuki Ojima, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/678,853

(22) Filed: Oct. 3, 2003

(30) Foreign Application Priority Data
Oct. 8, 2002 (JP) 2002-295211

(51) Int. Cl. H01M 8/18; H01M 4/92

(52) U.S. Cl. 429/13; 429/21; 429/40

(57) ABSTRACT

A process for generating power includes (1) generating power from a fuel cell including a fuel electrode, an air electrode and an electrolyte membrane sandwiched therebetween wherein the fuel electrode is made of an alloy including platinum, and a fuel is a liquid including a secondary alcohol, by directly feeding the fuel to the fuel electrode; (2) contacting the air electrode in the fuel cell with an oxidizable material and applying a current from an external electric source between the fuel electrode as negative and the, air electrode as positive, after step (1); and (3) generating power from the fuel cell after step (2).

### BACKGROUND OF THE INVENTION

1. Field of the Invention

This invention relates to a fuel-regenerable fuel cell using a secondary alcohol as a fuel, a process for generating power from the fuel-regenerable fuel cell and a process for regenerating the fuel.

2. Description of the Related Art

There have been extensive studies and developmental attempts for practically using a fuel cell as a clean energy source. Various fuels such as hydrogen and methanol have been intensely investigated.

Most of conventional fuel cells are those in which a fuel is fed from an external source and reacted in a fuel electrode to generate a product which is then discharged from the fuel cell. For example, hydrogen as a fuel generate only water as a product, which is discharged from the cell so that the fuel cell can be continuously run. Methanol as a fuel generates water and carbon dioxide as products, both of which are discharged from the cell.

It has been investigated to use a secondary alcohol such as 2-propanol as a fuel for a fuel cell (for example, see Non-patent Reference 1: Electrochem. Solid-State Lett., Vol. 5, A129-130 (2002), and Patent Reference 1: Japanese Patent Application No. 2001-353034). The subsequent studies, however, have revealed that the approach has a problem of accumulation of a reaction product from the fuel in a fuel container.

There has been described that acetone is reduced using a platinum electrode to generate propane (for example, see Non-patent Reference 2: J. Res. Inst. Catalysis, Hokkaido Univ., Vol. 25, No.2, pp.45-62 (1977)). It is substantially impossible to devise a fuel-regenerable fuel cell according to this invention, based on the results.

In a conventional fuel cell, a fuel fed from an external source is discharged as water and/or carbon dioxide. A reaction in which a reactant is oxidized to give an oxidized product which is accumulated in a fuel container is not necessarily satisfactory in the light of continuous use of the fuel cell. However, if the product can be regenerated by reduction, the fuel can be repeatedly used as a secondary battery.

Thus, there has been latently desired to develop a fuel-regenerable fuel cell, a process for generating power from the fuel cell and a process for regenerating the fuel.

### SUMMARY OF THE INVENTION

We have found that a redox reaction of a secondary alcohol and a ketone can efficiently proceed using a particular alloy electrode. Thus, we have utilized the alloy electrode as a fuel electrode in a fuel cell to achieve a fuel-regenerable fuel cell, a process for generating power and a process for regenerating the fuel.

A first aspect of the present invention lies in a process for generating power comprising:

a first step of generating power from a fuel cell comprising a fuel electrode, an air electrode and an electrolyte membrane sandwiched therebetween wherein the fuel electrode is made of an alloy comprising platinum and a fuel is a liquid comprising a secondary alcohol, by directly feeding the fuel to the fuel electrode;

a second step of contacting the air electrode in the fuel cell with an oxidizable material and applying a current from an external electric source between the fuel electrode as negative and the air electrode as positive, after the first step; and

a third step of generating power from the fuel cell after the second step.

According to a second aspect of the present invention, the fuel electrode may be made of an alloy of platinum and at least one metal selected from the group consisting of ruthenium, tin, tungsten, copper, gold, manganese and vanadium.

According to a third aspect of the present invention, the fuel electrode may be made of an alloy of platinum and at least one metal selected from the group consisting of ruthenium, tin and tungsten.

According to a fourth aspect of the present invention, the fuel electrode may be made of an alloy comprising platinum and ruthenium.

According to a fifth aspect of the present invention, an atomic composition ratio of platinum to the other elements in the alloy may be 90/10 to 10/90.

According to a sixth aspect of the present invention, the oxidizable material may be water or hydrogen.

According to a seventh aspect of the present invention, the process may further comprise a step of repeating the second step and the third step.

A eighth aspect of the present invention lies in a process for regenerating a fuel for a fuel cell from a spent fuel produced in the fuel cell, comprising:

a first step of generating power from a fuel cell comprising a fuel electrode, an air electrode and an electrolyte membrane sandwiched therebetween wherein the fuel electrode is made of an alloy comprising platinum and a fuel is a liquid comprising a secondary alcohol; and

a second step of feeding a reaction product of the secondary alcohol produced after using the fuel in the first step to a reduction electrode and an oxidizable material to an oxidization electrode outside the fuel cell and conducting electrolytic reduction using an external electric source to regenerate the secondary alcohol from the reaction product.

According to a ninth aspect of the present invention, the fuel electrode may be made of an alloy of platinum and at least one metal selected from the group consisting of ruthenium, tin, tungsten, copper, gold, manganese and vanadium.

According to a tenth aspect of the present invention, the reduction electrode may be made of an alloy of platinum and at least one metal selected from the group consisting of ruthenium, tin and tungsten.

According to an eleventh aspect of the present invention, an atomic composition ratio of platinum to the other elements in the alloy of the reduction electrode may be 90/10 to 10/90.

According to a twelfth aspect of the present invention, the reduction electrode may be made of an alloy comprising platinum and ruthenium.

According to a thirteenth aspect of the present invention, the oxidizable material may be water or hydrogen.

A fourteenth aspect of the present invention lies in a fuel cell comprising a fuel electrode, an air electrode and an electrolyte membrane sandwiched therebetween wherein

the fuel electrode is made of an alloy comprising platinum and ruthenium; a fuel is a liquid comprising a secondary alcohol; and the fuel is directly fed to the fuel electrode.

According to a fifteenth aspect of the present invention, the fuel electrode may be made of an alloy of platinum, ruthenium and tungsten or an alloy of platinum and ruthenium.

A sixteenth aspect of the present invention lies in a system for generating power comprising:

the fuel cell according to the fourteenth aspect of the present invention;

an external electric source capable of applying a current between the fuel electrode as negative and the air electrode as positive; and

a feeding means for feeding an oxidizable material to the air electrode.

A seventeenth aspect of the present invention lies in a system for generating power comprising:

the fuel cell according to the fourteenth aspect of the present invention and

an external electrolyzing means for regenerating a fuel for the fuel cell, comprising:

an electric source;

a reduction electrode for contacting a reaction product of the secondary alcohol produced after using the fuel in the fuel cell to regenerate the secondary alcohol from the reaction product; and

an oxidization electrode for contacting an oxidizable material.

### BRIEF DESCRIPTION OF THE DRAWINGS

FIG. 1 shows a single cell structure for a fuel cell.

FIG. 2 shows another embodiment of a fuel cell.

FIG. 3 shows an apparatus for regenerating a fuel outside of a fuel cell.

FIG. 4 shows a voltammogram (current-potential curve) in electrolytic oxidation of 2-propanol where an abscissa and an ordinate are an electrode potential and a reduction current value, respectively.

FIG. 5 shows a voltammogram (current-potential curve) in electrolytic reduction of acetone where an abscissa and an ordinate are an electrode potential and an oxidation current value, respectively.

### DETAILED DESCRIPTION OF THE PREFERRED EMBODIMENT

For describing this invention, a structure (configuration) of a fuel cell first will be described.

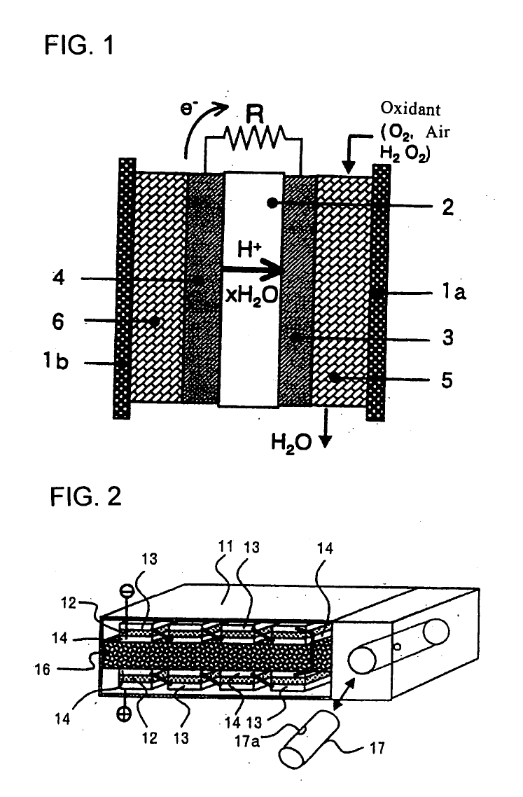

FIG. 1 shows an embodiment of a single cell structure for a common fuel cell. This embodiment may be also applied to this invention. In this figure, to an outward direction there are an ion-exchange membrane 2; an air electrode (cathode) 3 and a fuel electrode (anode) 4 sandwiching the membrane; and an oxidant channel 5 and a liquid fuel reservoir 6 in cases 1a, 1b.

The ion-exchange membrane 2 may be any ion conducting type, i. e., anionic or cationic. Suitably, it is proton conductive type. The ion-exchange-membrane 2 may be made of any of known materials such as a perfluoroalkylsulfonic acid polymer.

The air electrode 3 and the fuel electrode 4. may be a porous carbon paper on which a particular catalyst is applied; respectively. A membrane-electrode assembly can be formed by placing the electrolyte membrane 2 between the air electrode 3 and the fuel electrode 4 or laminating these three by, for example, hot pressing or cast film deposition. If necessary, a water repellent such as polytetrafluoroethylene may be added to or laminated on the porous carbon paper.

The fuel electrode 4 can be formed by mixing an ion conducting material with a carbon supporting an electrode, catalyst alloy described below and then contacting the mixture with the ion-exchange membrane 2.

The ion conducting material may be that for the ion-exchange membrane 2 for good results. Pressing the fuel electrode 4 onto the ion-exchange membrane 2 may be conducted by any known method such as hot pressing and cast film deposition.

In this invention, the fuel electrode 4 is made of an alloy comprising platinum, preferably an alloy of platinum and at least one metal selected from the group consisting of ruthenium, tin, tungsten, copper, gold, manganese. and vanadium, more preferably an alloy of ruthenium, tin and tungsten. Among these alloys, alloys comprising platinum and ruthenium are preferable; alloys consisting of platinum, ruthenium and tungsten and of platinum and ruthenium are most preferable. An atomic composition ratio of platinum to the other elements in the alloy is preferably 90/10 to 10/90.

The air electrode 3 can be also formed by mixing an ion conducting material with a carbon supporting platinum and then contacting the mixture with the ion-exchange membrane 2. When the ion conducting material is that for the ion-exchange membrane 2, good results can be obtained. Pressing the air electrode 3 onto the ion-exchange membrane 2 may be conducted by any known method such as hot pressing and cast film. deposition. Besides the carbon supporting platinum, air electrode 3 may be made of any known material such as noble metals, materials supporting a noble metal (electrode catalyst), organometallic complexes and their sintering products.

In the side of the air electrode 3, an oxidant inlet (not shown) for introducing an oxidant (often, the air) may be mounted in the upper part, while an oxidant outlet (not shown) for discharging unreacted air and a product (often, water) may be mounted in the. lower part. In this case, a forced intake and/or a forced exhaust means may be mounted. In the case 1a, a port for spontaneous convection of the air may be provided.

Outside of the fuel electrode 4, there is formed a liquid fuel reservoir 6. The liquid fuel reservoir 6 may be one for storing a secondary alcohol fuel or may be a channel to an external fuel reservoir (not shown). In this case, the fuel is stirred by spontaneous and/or forced convection. When forced convection is needed, a. forced convection means may be mounted.

According to our investigation, it has been found that higher electromotive force and output can be obtained when the fuel directly fed to the fuel electrode 4 contains a secondary alcohol such as isopropyl alcohol and isobutyl alcohol as a main component. Much higher cell electromotive force and output can be obtained when the fuel is a mixture of a secondary alcohol and water because crossover can be effectively prevented.

In this invention, the single cell shown in FIG. 1 can be used as it is. Alternatively, a plurality of single cells can be serially and/or pallallelly connected to form a mounted fuel energy. Cells can be interconnected by a conventional method using a bipolar plate or by a plane connection method described in, for example, “2000 Fuel Cell Seminar Abstracts”, pp.791, to 812. Any other known method may be, of course, employed.

FIG. 2 schematically shows another embodiment of a fuel cell according to this invention. The fuel cell shown in FIG. 2 has a flat and relatively thicker rectangular shape. In the fuel cell, a fuel-feeding channel 16 partitioning the cell into the upper and the lower parts is formed. The fuel cell has a reservoir for a liquid fuel consisting of a cylindrical container 17. The container 17 is removal from the fuel cell. The container 17 has a small port 17a on its side. The fuel in the container 17 is fed through the small port 17a. The small port 17a is sealed by a particular sealing. means (not shown) before the container 17 is mounted in the case, allowing the fuel to be enclosed in the container 17. When the container 17 is mounted in the fuel cell, the small port 17a is formed at the site communicated with the fuel-feeding channel 16.

The fuel cell comprises two or more cells. In particular, there is placed the first cell set consisting of four cells is placed above the fuel feeding channel 16 while the second cell set consisting of four cells is placed below the fuel feeding channel 16. Each cell consists of a fuel electrode 14, an air electrode 13 and an electrolyte membrane 12 between these, and individual cells are independent. The cells in these cell sets are arranged in a plane and connected in series. The cells in the first and the second cell sets are arranged such that their fuel electrodes 14 face to each other through the fuel-feeding channel 16. Furthermore, the cells in the first and the second cell sets are arranged such that their air electrodes 13 are directed outward. Employing such an arrangement of the cells, a fuel cell can be easily reduced in its size and become suitable for a compact power source, in particular a power source for a mobile device. Since the container 17 filled with a fuel is removable, the fuel can be easily supplied so that the fuel cell according to this invention can be suitable as a power source for a mobile device.

Fuel feeding from the container 17 to the fuel-feeding channel 16 is conducted for a liquid fuel containing a secondary alcohol as a main component. The channel is preferably made of, for example, a porous material prepared by sintering SiO₂ or Al₂O₃, a polymer fiber or a polymer porous film in the light of smooth feeding of the fuel. When using a polymer fiber or polymer porous film, it is necessary that these materials are not deformed when being in contact with the fuel.

In FIG. 2, it is preferable to place a fuel-blocking member (not shown) between laterally adjacent cells for preventing the fuel from reaching the air electrode 13 (a kind of crossover). For example, reaching of the fuel to the air electrode 13 can be prevented by filling a polymer material such as polyethylene and polypropylene, glass or an inorganic oxide such as aluminum oxide between adjacent cells.

The air electrodes 13 of the cells in the cell sets are directed outward as described above. In other words, the air electrode 13 faces the case. There is a space between the air electrode 13 and the case. Furthermore, the case has a vent hole (not shown) for communicating the space with the outside. The air, therefore, flows in the space between the air electrode 13 and the case by spontaneous convection. Thus, oxygen is fed to the air electrode 13. If it is desired to control feeding of the air to the air electrode 13, a forced convection means such as a fan may be mounted in a selected site of the case.

The secondary alcohol in the container 17 is oxidized by an oxidation reaction in the fuel electrode 14. In this invention, the secondary alcohol is mainly converted into a ketone, which remains in the container 17 without being discharged.

This invention is characterized in that the fuel electrode 14 and the air electrode 13 in FIG. 1 and 2 are connected to a negative pole and an positive pole in an external power source (not shown), respectively and electrolysis can be conducted to reduce a ketone accumulated in the fuel reservoir into the secondary alcohol. It is herein necessary to supply an oxidizable material to the anode in electrolysis via an oxidant channel. The oxidizable material may be moisture or hydrogen, which may be either liquid or gaseous.

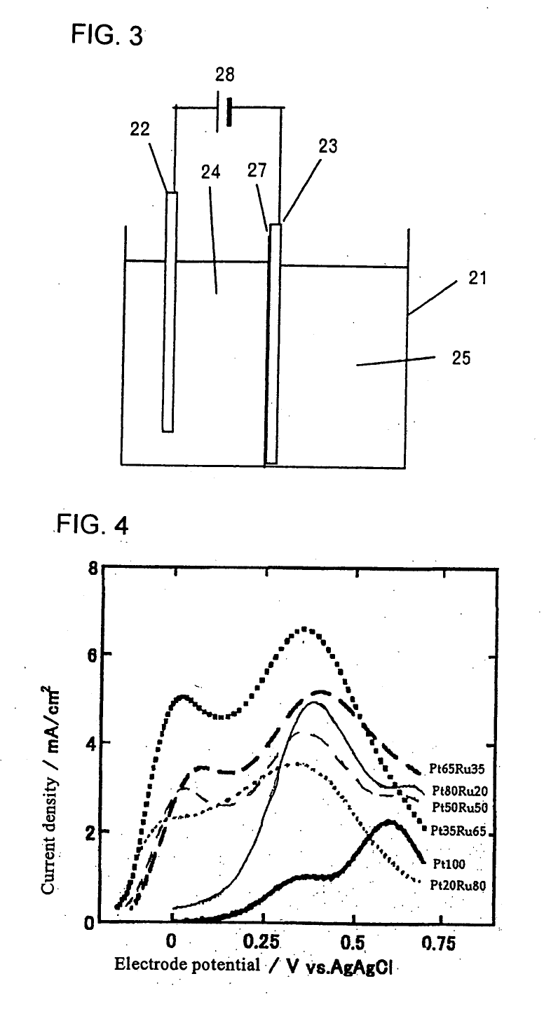

FIG. 3 shows an embodiment of an apparatus for reducing a ketone produced by oxidation of a secondary alcohol outside of the fuel cell. The apparatus comprises a direct-current source 28, an electrolytic bath 21 in which a reactant is charged, an oxidation electrode 22, a reduction electrode 23, an oxidizable material 24 and a liquid 25 containing an oxidation product from the secondary alcohol. The liquid 25 is a collected liquid containing a product after using the fuel cell. The electrolytic bath 21 is made of a material resistant to erosion or dissolution by, for example, an electrolytic 'solution. Examples of such a material which can be used include metals such as iron, alloy, brass and stainless, glasses, plastics, metal oxides, metal nitrides, metal carbides and composite materials thereof. Such an electrolytic bath may be improved in solution resistance by processing the inside of the bath with a fluororesin or enamel.

In FIG. 3, a septum 27 and the reduction electrode 23 are glued together. The reduction electrode chamber can be charged with a liquid 25 containing an oxidization product from the secondary alcohol. The desired electrolysis may efficiently proceed by using the oxidizable material 24 comprising any of the various materials which can initiated an electrode oxidation reaction. The oxidizable material 24 may be comprised of a material involving an anode reaction alone. In other words, an extremely higher reactant concentration may be employed to promote all the reactions. Specifically, water may be fed as a gas or liquid, or hydrogen gas may be charged or flown alone or in combination with a dilution gas. Alternatively, an aqueous solution of ferrous chloride may be used. Alternatively, liquid methanol or methanol vaporized by heating may be charged or flown.

The reduction electrode 23 in FIG. 3 is preferably porous. Such a reduction electrode may be, for example, a known electrode such as a sponge electrode and a composite electrode. A composite electrode is an electrode formed by shaping a mixture of a conductive material and an appropriate material such as glasses, plastics, metal oxides, metal nitrides, metal carbides and composites thereof, if necessary, adding a binder resin, and is highly gas-permeable because it has a number of micropores. Examples of a conductive material which can be used generally include metals such as iron, copper and nickel; alloys such as brass and stainless; and carbon materials such as carbon black, graphite, fullerene and carbon-nanotube. A semiconductor or insulating material may be mixed with or dispersed into any of these materials, and then the mixture can be shaped by a well-known process such as hot-pressing, cast film deposition and powder metallurgy. The binder resin used as necessary may be any of thermoplastic and thermosetting resins. In particular, an ion-exchange resin can be used as a binder for a composite electrode to. efficiently effect the electrode reaction because the whole inside of the composite electrode layer is used as a reaction field. Examples of an electrode catalyst material which can be suitable used are alloys of platinum and at least one metal selected from the group consisting of ruthenium, tin and tungsten. Among these alloys, preferable are alloys comprising platinum and ruthenium, most preferable are an alloy consisting of platinum, ruthenium and tungsten, and an alloy consisting of platinum and ruthenium, in which a ruthenium content is 70 to 90 at %.

As an application of the apparatus in FIG. 3, an oxidation electrode may be contacted with the oxidation-electrode-chamber side of the septum 27 (not shown) and the apparatus can be satisfactorily used in practice. An electrolytic bath having this structure is referred to as a “membrane electrolysis system” and has advantages such as a small size, a light weight and good handling properties because the whole structure can be compacted.

In this invention, a fuel comprises a secondary alcohol as a main component. A secondary alcohol in the fuel preferably has 3 to 20 carbon atoms, more preferably 3 to 10 carbon atoms. Aliphatic alcohols such as isopropyl alcohol and sec-butyl alcohol are preferably used as a secondary alcohol in the fuel.

This invention is illustrated with reference to the following examples.

### PREPARATION EXAMPLE 1

An alloy electrode was prepared as described below.

Using a sputtering apparatus (L-350S, Anelva corporation), a substrate was sputtered under an argon atmosphere of 10 Pa at 150° C. While simultaneously opening shutters for sputtering targets, a chamber was rotated at a rate of 20 rpm to initiate sputtering and thus to prepare an alloy having a composition of Pt:Ru=80:20 to 10:80. Alloys having the compositions shown in Tables 1 and 2 were also prepared as described above.

### TEST EXAMPLE 1

Using the Pt-Ru alloy having a composition of Pt:Ru=80:20 to 10:80 prepared in Preparation Example 1 and a Pt electrode, electrolytic oxidation of 2-propanol (0.5 M) and electrolytic reduction of acetone (0.5 M) in a 1M aqueous solution-of sulfuric acid were effected by potential sweeping using a three-electrode electrochemical cell and a potentiostat, where a reference electrode was Ag/AgCl.

The alloy-sputtered substrate was used as a working electrode, a counter electrode was a Pt coil, and a measurement solution was a nitrogen-degassed mixture of 0.5 M aqueous sulfuric acid solution and 1M aqueous 2-propanol solution. Potential sweeping was conducted using a potentiostat (Bipotentiostat HA1010, Hokuto Denko corporation) to initiate electrolytic oxidation of 2-propanol. FIG. 4 shows the results of a voltammogram (current-potential curve) output where an electrode potential and a measured oxidation current were the abscissa and the ordinate, respectively. In this figure, the electrode having a composition of Pt:Ru=35:65 demonstrated good results that a transient build-up potential of the current was base (a potential direction to negative is called “base” because there is not an absolute standard for an electrode potential) and the maximum current value was higher.

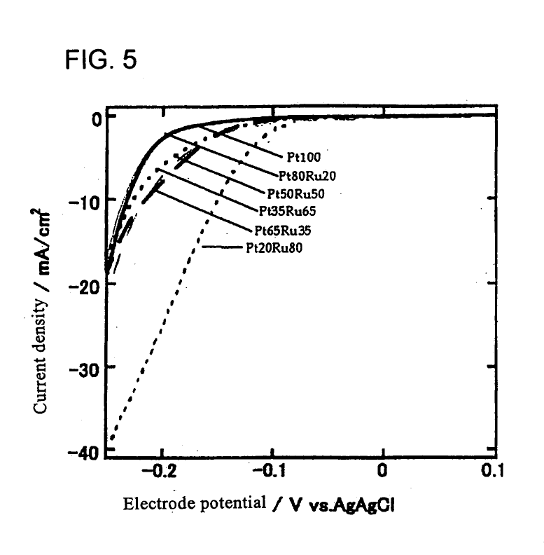

Similarly, FIG. 5 shows a voltammogram for electrolytic reduction of acetone using a nitrogen-degassed mixture of 0.5 M aqueous sulfuric acid solution and 1 M aqueous acetone solution as a measurement solution. In this figure, the electrode having a composition of Pt:Ru=20:80 demonstrated good results that a transient build-up-potential of the current was noble (a potential direction to positive is called “noble” because there is not an absolute standard for an electrode potential) and the maximum current value was higher.

In other words, the results in FIGS. 4 and 5 indicate that an electrode having a composition of Pt:Ru=65:35 to 20:80 exhibits good properties for oxidation of 2-propanol and reduction of acetone.

### TEST EXAMPLE 2

Electrolytic oxidation of 2-propanol was effected using the Pt alloy having the composition shown in Table 1 prepared in Preparation Example 1 and a Pt electrode under the conditions as described in Test Example 1. The results are shown in Table 1.

TABLE 1

| Substrate | | 2-Propanol | | | |
|---|---|---|---|---|---|
| (temp. | Catalyst | Rest | | Current | |
| during | (Composition: | Potential | | density | |
| sputtering) | atomic ratio) | (V) | Rating | (mA/cm²) | Rating |
| Pt/Si | Pt | 0 | normal | 1.0 | normal |
| substrate | Pt:Ru = 50:50 | −0.15 | +++ | 6.3 | ++ |
| (150° C.) | Pt:W = 85:15 | 0 | − | 10.8 | +++ |
| | Pt:Sn = 95:5 | −0.075 | ++ | ˜1.0 | − |
| Au | Pt:W = 85:15 | 0 | − | 18 | +++ |
| substrate | Pt:Ru:W = | −0.05 | + | 25 | +++ |
| (300° C.) | 65:20:15 | | | | |
| | Pt:Ru:Sn = | −0.1 | ++ | ˜1.0 | − |
| | 60:15:25 | | | | |
| Pt | Pt:W = 85:15 | 0 | − | 23.9 | +++ |
| substrate | Pt:Ru:W = | −0.05 | + | 14.3 | +++ |
| (300° C.) | 65:20:15 | | | | |
| | Pt:Ru:Sn = | −0.1 | ++ | ˜1.0 | − |
| | 60: 15:25 | | | | |

In this table, rating is determined in comparison with a Pt electrode, indicating “+++”: significant improvement and increase; “++”: improvement and increase; “+”: relative improvement and increase; and “−”: no substantial. improvement. The rating was determined comparison of a rest potential (spontaneous potential: the more negative the value is, the higher a battery electromotive force is) and a current density at 0.4 V vs Ag/AgCl.

The results demonstrate that an electrode material used in this invention exhibits good performance in electrolytic oxidation of 2-propanol, compared with the conventional platinum electrode. In particular, it is demonstrated that the Pt/Ru/W alloy is excellent.

### TEST EXAMPLE 3

Electrolytic reduction of acetone was effected using the Pt alloy having the composition shown in Table 2 prepared. in Preparation Example 1 and a Pt and a Ru electrodes under the conditions as described in Test Example 1. The results are shown in Table 2.

TABLE 2

| Substrate | | Acetone | | | |
|---|---|---|---|---|---|
| (temp. | Catalyst | Rest | | Current | |
| during | (Composition: | Potential | | density | |
| sputtering) | atomic ratio) | (V) | Rating | (mA/cm²) | Rating |
| Pt/Si | Pt | nd | nd | −2.6 | normal |
| substrate | Pt:Ru = 20:80 | 0.15 | +++ | −24.9 | +++ |
| (150° C.) | Ru | nd | nd | −2.8 | − |
| Au | Pt:W = 85:15 | 0.07 | + | −7.8 | ++ |
| substrate | Pt:Ru:W = | 0.1 | ++ | −14.2 | +++ |
| (300° C.) | 65:20:15 | | | | |
| | Pt:Ru:Sn = | 0.15 | +++ | −8.2 | ++ |
| | 60:15:25 | | | | |
| Pt | Pt:W = 85:15 | 0.05 | + | −14.9 | +++ |
| substrate | Pt:Ru:W = | 0.03 | + | −15.9 | +++ |
| (300° C.) | 65:20:15 | | | | |
| | Pt:Ru:Sn = | 0.15 | +++ | −1.0 | − |
| | 60:15:25 | | | | |

In this table, “nd” indicates that a potential value cannot be provided due to inertness to acetone. Rating is determined in comparison with a Pt electrode, indicating “+++”: significant improvement and increase; “++”: improvement and increase; “+”: relative improvement and increase; and “−”: no substantial improvement. The rating was determined comparison of a rest potential (spontaneous potential: the more positive the value is, the more reduction is accelerated) and a current density at −0.2 V vs Ag/AgCl. For a rest potential, evaluation is based on relative comparison because it cannot be compared with that for the Pt electrode.

The results demonstrate that an electrode material used in this invention exhibits good performance in electrolytic reduction of acetone, compared with the platinum electrode described in Non-patent Reference 2. In particular, it is demonstrated that the Pt/Ru/W alloy and the Pt/Ru alloy with a higher Ru content are excellent.

### EXAMPLE 1

The alloy having a Pt:Ru atomic ratio of 50:50 prepared in Preparation Example 1 was used as a fuel electrode in a commercially available direct methanol type fuel cell (DMFC, H-TEC corporation).

In a fuel-electrode container in the fuel cell was charged with an aqueous solution of 2-propanol (0.5 M) as a fuel, and then power generation (discharge) was effected by applying an oxidation current of 32 mA/cm² using a potentiogalvanostat.

For determining a solution composition after power generation, 2 μL aliquots of the fuel solution were collected using a microsyringe at 5, 30, 60, 90 and 120 min after the initiation of power generation, and the samples were analyzed by gas chromatography. A solution concentration was determined using a peak integration value in a gas chromatogram. Variation of a solution concentration over time is shown in Table 3.

TABLE 3

| | |
|---|---|
| Time | Solution concentration (mol/L) |

| (min.) | 2-Propanol | Acetone |
|---|---|---|
| 0 | 0.500 | 0.000 |
| 5 | 0.497 | 0.003 |
| 30 | 0.468 | 0.016 |
| 60 | 0.405 | 0.046 |
| 90 | 0.369 | 0.061 |
| 120 | 0.328 | 0.070 |

Then, in the fuel-electrode container in the fuel cell was charged with an aqueous solution of acetone (0.5 M), and electrolysis was effected by applying a reduction current of 32 mA/cm² under the conditions of 25° C. and 65% RH using a potentiogalvanostat. As described for 2-propanol, a solution composition was analyzed by gas chromatography. Table 4 shows variation of a solution concentration over time.

TABLE 4

| | |
|---|---|
| Time | Solution concentration (mol/L) |

| (min.) | Acetone | 2-Propanol |
|---|---|---|
| 0 | 0.500 | 0.000 |
| 5 | 0:396 | 0.017 |
| 30 | 0.307 | 0.074 |
| 60 | 0.238 | 0.125 |
| 90 | 0.176 | 0.155 |
| 120 | 0.115 | 0.184 |

These results demonstrate that interconversion between the fuel 2-propanol and the product acetone efficiently proceeded.

### COMPARATIVE EXAMPLE 1

Reduction of a 0.5 M aqueous solution of acetone was attempted under the conditions of 25° C. and 5% RH as described in Example 1, but a weak current of 2 mA/cm² or lower was obtained. It indicates that effective (adequate) feeding of an oxidizing material (water in this case) to an oxidation electrode is essential.

Effect of the Invention

According to the invention, a redox reaction of a secondary alcohol and a ketone can be efficiently accomplished using a particular alloy electrode, and an efficient fuel-regenerable fuel cell, both an efficient system and process for generating power and an efficient process for regenerating fuel can be provided.

This application claims priority to Japanese Application No. 2002-295211, filed Oct. 8, 2002, the disclosure of which is herein incorporated by reference in its entirety.

What is claimed is:

1. A process for generating power comprising:
a first step of generating power from a fuel cell comprising a fuel electrode, an air electrode and an electrolyte membrane sandwiched therebetween wherein the fuel electrode is made of an alloy comprising platinum and a fuel is a liquid comprising a secondary alcohol, by directly feeding the fuel to the fuel electrode;
a second step of contacting the air electrode in the fuel cell with an oxidizable material and applying a current from an external electric source between the fuel electrode as negative and the air electrode as positive, after the first step; and
a third step of generating power from the fuel cell after the second step.

2. The- process as claimed in claim 1, wherein the fuel electrode is made of an alloy of platinum and at least one metal selected from the group consisting of ruthenium, tin, tungsten, copper, gold manganese and, vanadium.

3. The process as claimed in claim 1, wherein the fuel electrode is made of an alloy of platinum and at least one metal 'selected from the group consisting of ruthenium, tin and tungsten.

4. The process as claimed in claim 1, wherein the fuel electrode is made of an alloy comprising platinum and ruthenium.

5. The process as claimed in claim 1, wherein an atomic composition ratio of platinum to the other elements in the alloy is 90/10 to 10/90.

6. The process as claimed in claim 1, wherein the oxidizable material is water or hydrogen.

7. The process as claimed in claim 1, further comprising, a step of repeating the second step and the third step.

8. A process for regenerating a fuel for a fuel cell from a spent fuel produced in the fuel cell, comprising:
a first step of generating power from a fuel cell comprising a fuel electrode, an air electrode and an electrolyte membrane sandwiched therebetween wherein the fuel electrode is made of an alloy comprising platinum and a fuel is a liquid comprising a secondary alcohol; and
a second step of feeding a reaction product of the secondary alcohol produced after using the fuel in the first step to a reduction electrode and an oxidizable material to an oxidization electrode outside the fuel cell and conducting electrolytic reduction using an external electric source to regenerate the secondary alcohol from the reaction product.

9. The process as claimed in claim 8, wherein the fuel electrode is made of an alloy of platinum and at least one metal selected from the group consisting of ruthenium, tin, tungsten, copper, gold, manganese and vanadium.

10. The process as claimed in claim 8, wherein the reduction electrode is made of an alloy of platinum and at least one metal selected from the group consisting of ruthenium, tin and tungsten.

11. The process as claimed in claim 10, wherein an atomic composition ratio of platinum to the other elements in the alloy of the reduction electrode is 90/10 to 10/90.

12. The process as claimed in claim 8, wherein the reduction electrode is made of an alloy comprising platinum and ruthenium.

13. The process as claimed in claim 8, wherein the oxidizable material is water or hydrogen.

14. A fuel cell comprising a fuel electrode, an air electrode and an electrolyte membrane sandwiched therebetween wherein
the fuel electrode is made of an alloy comprising platinum and ruthenium; a fuel is a liquid comprising a secondary alcohol; and the fuel is directly fed to the fuel electrode.

15. The fuel cell as claimed in claim 14 wherein the fuel electrode is made of an alloy of platinum, ruthenium and tungsten or an alloy of platinum and ruthenium.

16. A system for generating power comprising:
the fuel cell as claimed in claim 14;
an external electric source capable of applying a current between the fuel electrode as negative and the air electrode as positive; and
a feeding means for feeding an oxidizable material to the air electrode.

17. A system for generating power comprising:
the fuel cell as claimed in claim 14 and
an external electrolyzing means for regenerating a fuel for the fuel cell, comprising:
an electric source;
a reduction electrode for contacting a reaction product of the secondary alcohol produced after using the fuel in the fuel cell to regenerate the secondary alcohol from the reaction product; and
an oxidization electrode for contacting an oxidizable material.
